(19) United States
(12) Patent Application Publication
(10) Pub. No.: US 2018/0260195 A1
(43) Pub. Date: Sep. 13, 2018

(54) METHOD FOR BUILDING NATIVE ECOMMERCE MOBILE APPLICATION

(71) Applicant: MUTHUKRISHNAN GOVINDARAJ, PARLIN, NJ (US)

(72) Inventor: MUTHUKRISHNAN GOVINDARAJ, PARLIN, NJ (US)

(21) Appl. No.: 15/456,683

(22) Filed: Mar. 13, 2017

(51) Int. Cl. G06F 9/44; G06Q 30/02; G06Q 30/06

(52) U.S. Cl. CPC G06F 8/38; G06Q 30/0276; G06F 8/35; G06F 8/34; G06Q 30/0641

(57) ABSTRACT

Elite mCommerce is having a Software-as-a-Service (SaaS). The system allows merchants or administrator to design their native ecommerce mobile app pages using drag and drop interface. The merchants can design the page with ecommerce elements which used to have dynamic data like, cart, price, discount, product, search products, ad banners, promotional banners, product category display, product navigation, content information etc. The system uses temporary work area where the merchant can design interfaces for the native ecommerce mobile app screen and link them to Uniform Resource Identifier (URI) for that content or section in that native mobile app screen to a category of the products, to a particular product, to a particular keyword search link (as deep link URI), particular content screen within the native ecommerce mobile app. This invention page builder for native ecommerce mobile application uses drag and drop and provides preview for mobile apps in HTML web screen. As soon as the mobile app screen is designed in the mobile app builder page for eCommerce, it will be published to mobile devices of end customers' ecommerce application screen, immediately without any code build process as native mobile elements avoiding web-view, hybrid or HTML5 techniques. The new design will be reflected in the ecommerce application of the user mobile device instantly.

The new design layout and parameter information are dynamically loaded from ecommerce back end web-server as JSON data via RESTful web services and are stored within the native ecommerce mobile app as local data. The new design layout and parameter information includes the page design layout code information, content information, URI information for images and media assets and page render priority order and other element property information.

### FIELD OF INVENTION

The invention is in relation with general computer systems and is specific for building the screens for a native mobile ecommerce application development.

### BACKGROUND OF THE INVENTION

Smartphones and mobile applications are mostly used by people nowadays. People are using mobile ecommerce applications for buying things online, avail services online with a tap. While purchasing products and services online through native ecommerce mobile applications, people prefer to engage in those ecommerce mobile applications.

For a continuous engagement within the ecommerce mobile applications, the users prefer to see new contents, new offers, new banner images in the native ecommerce mobile applications. Otherwise they may not open or use the native ecommerce mobile application. And the mobile application merchant may lose those users.

The mobile application merchants are in need of a tool to make their mobile application users always engaged with new contents, banner images, new offers, promotional banners, mobile application theme colors and layouts. The problems with the existing methods are such that they don't have provisions or method for building native ecommerce mobile application screens. Additionally those arts don't have provision for creating mobile ecommerce elements like banners, cart, price, promotional, discount, product navigations, deep link URI, content text in a drag and drop builder interface for native ecommerce mobile application. This has been overcome in current invention.

The prior arts doesn't have provision for managing multiple language text editing for the native ecommerce mobile application from this drag and drop page builder. In addition to that the existing inventions doesn't have provision for managing multiple templates of native ecommerce mobile application screen designs so that they can switch between templates and if any change required in design, the design has to be changed in code level for native ecommerce mobile application. This has been overcome in present invention. The mobile application merchant requires a software tool using which the merchants can design the mobile application screens for their ecommerce mobile application. Using the proposed system the merchant can publish the designed screens to their native ecommerce mobile application without any code build process and without any application resubmitting process. The proposed method or system for building native ecommerce mobile application must not require the merchants to learn any programming knowledge to design or change their native ecommerce mobile application.

The proposed new application must have the features of simple interface for merchant users like drag and drop screen elements and simple configuration user interfaces for designing ecommerce mobile application screens. Various other page builder methods have been devised in art; some of them are as follows:

The invention ‘Mobile application builder’ U.S. Pat. No. 7,184,801 B2 [Feb. 27, 2007], is an invention that claims to have GUI interface using which mobile GUI interface to build applications based on existing application on the mobile device. And there will be indicators which will define which database or application or the commands to execute. This invention lacks the feature of building screens for ecommerce native mobile application screen elements and pages.

The patent ‘Method and system for providing message publishing on a dynamic page builder on the internet’ U.S. Pat. No. 7,861,155 B2 [Dec. 28, 2010] is a page builder tool which stores messages in cache agent and publish the message through message publishing agent. Message publishing agent will display the message on web browser through this page builder tool utilizing the message cache. This system doesn't have the features to help or identify the methods for building ecommerce elements dynamically in a native ecommerce mobile application.

The patent ‘Drag and drop creation and editing of a page incorporating scripts’ U.S. Pat. No. 6,714,219 B2 [Mar. 30, 2004] describes an environment that supports for event-driven programming and the execution of the computer programs in a serial execution paradigm. This invention describes how to treat scripts for a later definable object to reduce the designing phase for a page.

The technique ‘Method and apparatus for generating and modifying multiple instances of element of a web site’ U.S. Pat. No. 6,697,825 B1 [Feb. 24, 2004] explains about modifying and generating the website elements or characters based on the data entry from multi-dimensional description of the website and determination of the characteristics.

### OBJECTS OF THE INVENTION

One or more of the problems of the conventional prior art may be overcome by various embodiments of the present invention, including this method doesn't require resubmitting and relaunch of the app to the respective mobile app stores.

accordingly, the primary object of the present invention is to provide a method for building a native ecommerce mobile application screens by an user who doesn't have computer software programming knowledge but using simple drag and drop mobile ecommerce elements web application interface.

One object of the present invention is to provide a drag and drop mobile ecommerce elements interface and build native ecommerce mobile application screens.

It is one object of the present invention, wherein the said interface will give facility to user to build different mobile commerce elements like but not limited to, dynamic cart element, dynamic product price display element, dynamic discount display element, dynamic ad banners and promotional banners display element, dynamic product navigation element, dynamic product deep link URI element as search request link, dynamic application content information element.

It is another object of the present invention, wherein the designed elements are managed as multiple page templates that can be switched between different templates by means of application programming interface.

It is one another object of the present invention, wherein the designed elements and page templates are stored in the user's mobile device and native ecommerce mobile application by means of local data storage and cache storage.

It is yet another object of the present invention, wherein the merchant can manage the multiple currency and multiple languages for the designed template information rendering by means of one or more application programming.

It is even another object of the present invention, wherein the templates version system are used for identifying the latest active template design for the native ecommerce mobile application screens and load templates without any code build process but with a click of a buttons in configuration page in ecommerce web application.

It is one object of the present invention, wherein the said application doesn't require special maintenance as it is updated timely.

### SUMMARY OF THE INVENTION

The system and method of building native ecommerce mobile application is a separate cloud based web application and interface that is connected with ecommerce webserver.

This web interface have provision for drag and drop of the ecommerce mobile application elements like banners, cart, price, promotional, discount, product navigations, deep link URI, content text. The merchant user can drag and drop these elements to the design area.

The design area will have the provision to preview the designed elements and help to understand how it will be looking like in mobile device screens.

The merchant user can design as many as design templates for their native ecommerce mobile application and store them as multiple templates to choose from.

The merchant user can select also configure different language texts, elements, and other properties being used within the design of the mobile application screen.

All these design elements, properties, language texts, references to the media assets and images within the mobile application screen design are stored as a JSON data within the database in design application's web server.

This JSON design information is transferred to the ecommerce web server to serve to the mobile applications directly from ecommerce web server.

When the ecommerce mobile application user opens the mobile app, the application will check in ecommerce server for the active version of the design template and if there is a new version of design template available in the server then the server will send the JSON design information to the mobile application and store them within the mobile device local data storage or cache storage

If there is no change in the version number of the design template in ecommerce web server then the design information available in the mobile device will be rendered to display in the ecommerce mobile application.

Similarly the mobile application user can also select a particular store available in that ecommerce mobile application if the ecommerce mobile application is having multiple store environments.

The merchant user can configure the ecommerce mobile application screens with the user language, currencies format for the products content, product price, banner texts in the page design screens. These will be displayed in the native ecommerce mobile application when the user selects the particular language or currency in the application front end.

The merchant user can design and configure dynamic product and product categories loading from the ecommerce server to the design elements in the mobile application page design.

This method for building ecommerce mobile application pages helps merchant to design many templates and use them for appropriate occasions, seasonal offer campaigns.

The merchant user can use these designed templates to serve geo targeted users, i.e. particular region of the users can only view specific design template whereas the rest of the users can see a unique different screens.

The merchant user can also use these designed templates to serve particular user groups, i.e. particular gender or age group of the users can only view specific design template whereas the rest of the users can see a unique different screens. These features [0032], [0033] and [0034] can be served for particular time period (from date and two dates).

### BRIEF DESCRIPTION OF THE DRAWINGS

FIG. 1 is the high-level system design diagram for the native ecommerce mobile app builder application. The system consists of four sections namely, native ecommerce mobile application builder web interface, ecommerce web server, mobile commerce application programming interface (API) and Mobile device with ecommerce mobile application.

FIG. 2 is the system functional flow chart of the design and preview process that describes how the system for native ecommerce mobile app builder is functioning in the flow of loading data from ecommerce web server, design process by merchant in this mobile ecommerce elements design interface and preview the design and then saving the design template as JSON data in ecommerce web server through REST API.

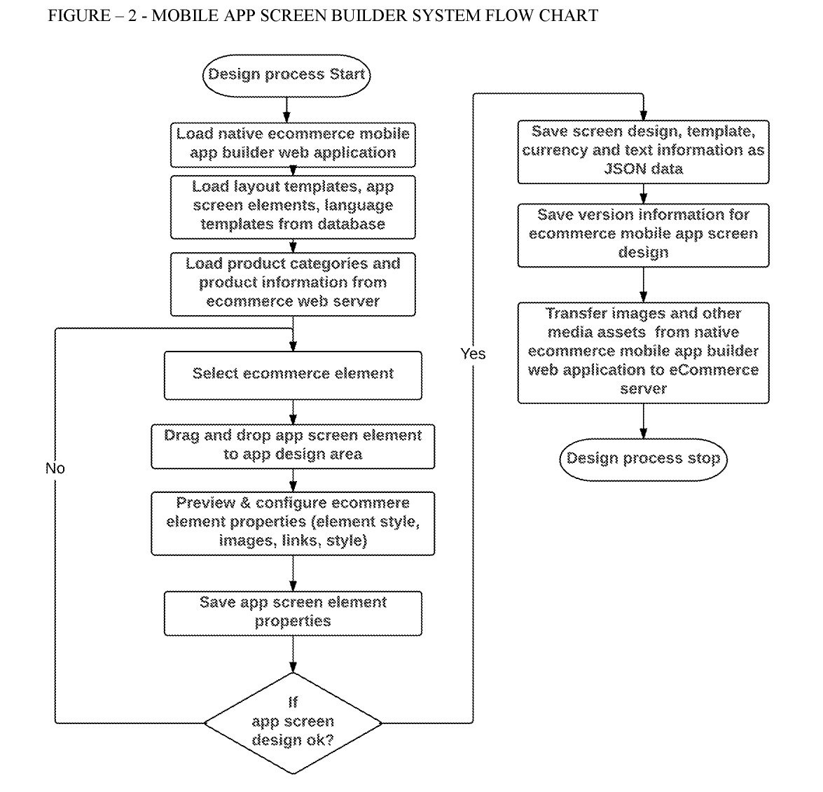

FIG. 3 is the functional flow of the designs and rendering of design from ecommerce (mobile) server and from mobile device local data storage.

FIG. 4 illustration explains the process of publishing the native ecommerce mobile application design without resubmitting to app store and no launch process. The new design screen will be reflected in native ecommerce mobile application immediately.

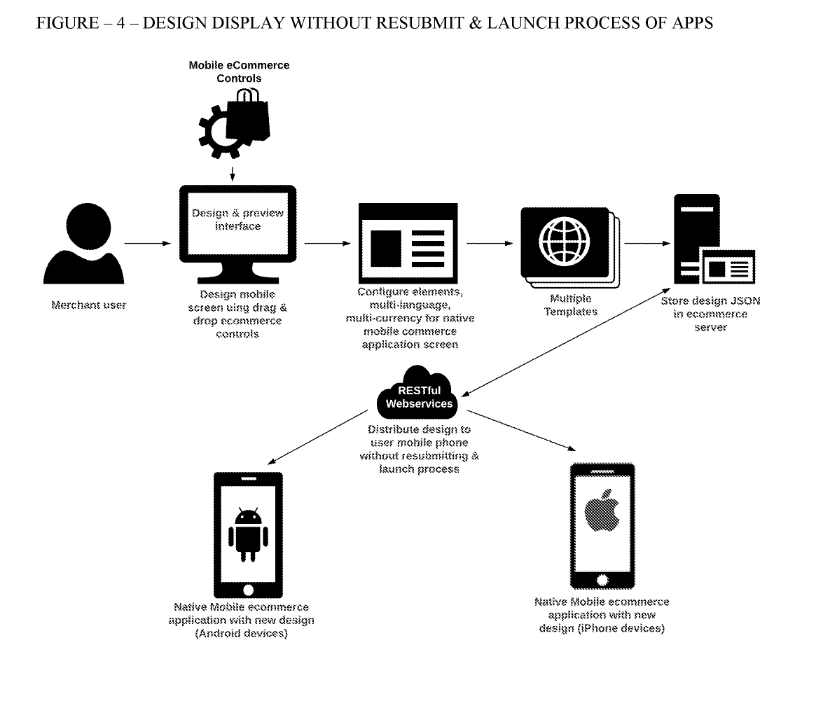

### DETAILED DESCRIPTION OF THE INVENTION DRAWINGS

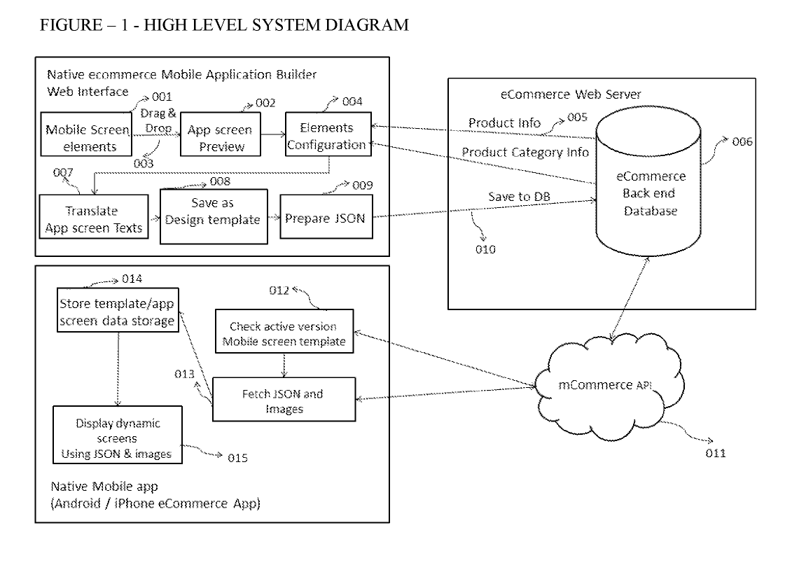

In one of the embodiments, FIG. 1 of high-level system design, there are four sections namely, native ecommerce mobile application builder web interface, ecommerce web server, mobile commerce application programming interface (API) and Mobile device with ecommerce mobile application.

In the said embodiment, the first section native ecommerce mobile application builder, the mobile ecommerce elements interface for displaying available ecommerce design (001) elements like promotional banners, product navigation, product deep link URI, product information content, shopping cart, product price and discount banners. But these design elements are not limited to this list.

From this embodiment, there is a sub-section, the app screen preview and build (002) section which will give a preview of the design to the merchant how the design will look like in mobile devices.

In the above said sub-section the merchant user can drag and drop (003) the mobile screen elements promotional banners, product navigation, product deep link URI, product information content, shopping cart, product price and discount banners but not limited to this list, as a designing process.

This embodiment section, native ecommerce mobile application builder web interface may have HTML, CSS and JavaScript and AJAX web interfaces.

Next in this embodiment, another sub-section is the elements configuration (004), where the merchant user can configure or setup the designed screen elements with specific property values.

The specific property values can be like, image URL for the banner design element, product link for the product element, product category link for the product category element, static content for the content element, banner image type and size for the banner design element, font color, font style, size and font alignment for the text design elements, currency information element for the product prices to be displayed etc.,

The system uses REST API to fetch the product information and product category information (005) from another section in the embodiment, ecommerce back end database (006). Using this information it will be populated in the sub-section elements configuration and the merchant user can select the values for the properties from the available list.

Then merchant user can configure the app screen texts and its translations (007) for the elements designed in the mobile application screens. The application uses grid like interface and uses translation service to help merchant user to define the translations for all the texts used in the design.

Once all the translations are configured the merchant user is ready to save this design. The designs for the mobile application screen are saved as template (008) and version number for the template. The merchant user can also configure this design to which screen this design will be applicable for. The screens that this design may be applicable are home page design, product listing screen, product detailed view screen, shopping cart process screens but this screen list and usage are not limited. Whenever the user loads this template from the templates list library, and edit the design, the template will be saved as new version.

The merchant user will also have interface for saving the template as active template and only one template from all available template designs can be made as active.

When the designs are prepared to save as template, the design configurations are translated into JSON format (009) and stored in to the ecommerce back end database (010).

The other two sections of the embodiment are, mCommerce API and mobile device with native ecommerce mobile application. The mCommerce API (011) will fetch the active design template information from the ecommerce back end server.

The sub-section in the said embodiment will check for the version number of the design template currently used in the native ecommerce mobile application against the version number from server (012). If the version number differs then the active template from ecommerce web server will be fetched (013) and it will be stored as a cache in local data storage of the native ecommerce mobile application (014).

The native ecommerce mobile application will then display the design elements (015) using the information fetched from ecommerce server back end database. Thus the design can be changed or modified without any code build process for the mobile app. The design information being displayed is dynamically loaded.

There is another embodiment, that describes the design process functional flow of this design process in the native ecommerce mobile application builder.

This section explains the functional flow of the present invention and its usage in a ecommerce mobile screen page builder tool within a computer system. The processes from [0038] to [0048] are illustrated in this functional flow chart of the system.

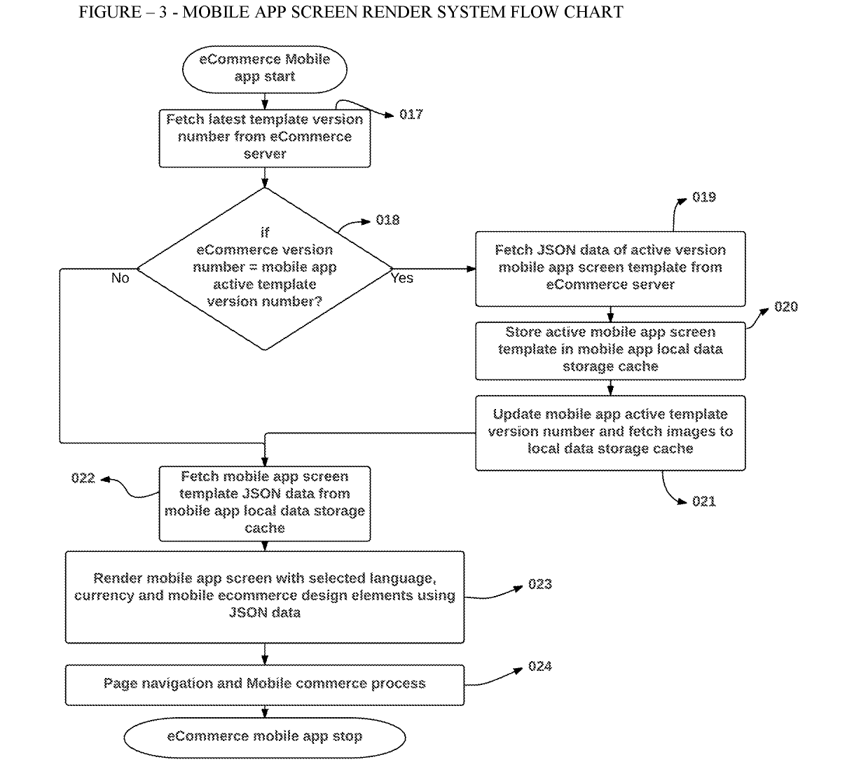

In another exemplary embodiment, FIG. 3, ecommerce mobile application designed pages display process uses the end users' smart phone device.

In this embodiment, the process starts from the section fetching the latest version number of the active design template from ecommerce web server (017)

In this same embodiment, the version number will be verified (018) against the version number of the mobile screen design template being used in the users' mobile device.

If the version numbers are same, then there are no changes in the design elements and will go to step [0064]

If the mobile device version number is less than the ecommerce server version number then there is a change in design template in ecommerce web server.

Then the system in mobile application will fetch the JSON data for the active template version from ecommerce web server to mobile application (019).

In this step, the template design asset and media elements but not limited to, images, videos, product information, product URLs etc., will be fetched from ecommerce server to local data storage and will be cached (020). So for further request for rendering of mobile application screen where the version numbers are same, it will be displayed from local data storage cache.

The version number for the template in the mobile device being used will also be updated (021) with the version number of the template received from ecommerce web server.

The template design asset and media elements and other information are fetched from cache storage (022) in mobile device (local data storage)

The template design, assets, images, product URLs, product categories, contents, deep link URIs, banner images, promotional images, product price and discount information and cart information in the respective language text and in selected currency will be displayed from local data storage (023).

The user can then browse the native ecommerce mobile application, browse through ecommerce mobile application screens and uses the application (024) for buying and checkout process from mobile.

Although only a few exemplary embodiments of this invention have been described in detail above, those skilled in the art will readily appreciate that many modifications are possible in the exemplary embodiments. Accordingly, all such modifications are intended to be included in the scope of this invention as defined in the following claims. In the claims, means-plus-function clauses are intended to cover the structures described herein as performing the recited function and not only structural equivalents, but also equivalent structures.

This invention is further described through the above said working mode of the said methods and processes of the native ecommerce mobile application builder, which is only illustrative in the nature and should not be construed to limit the scope of invention.

1. A system of drag and drop graphical user interface with ecommerce control elements for building native ecommerce mobile application, where the merchant users can design themselves using this web graphical user interface for their native ecommerce mobile application without resubmitting to the app stores. The merchant user can able to preview the design in this web interface to understand how this page design will look into the native ecommerce mobile application. The merchant user can build different mobile ecommerce elements like cart, product price and discount information, ad and promotional banner, product navigation and dynamic page content for the native ecommerce mobile application.

2. The system of claim 1, wherein the native ecommerce mobile application builder is a scripting web application, drag and drop graphical user interface to design native ecommerce mobile application page instantly and doesn't require resubmitting the mobile app to the app stores for this new design to be distributed to end users. Additionally, one must note that this claim of drag and drop builder feature doesn't apply or cannot be referenced with the system of drag and drop building interfaces used for web applications or HTML applications.

3. The system native ecommerce mobile application builder of claim 1 allows the user to design and build mobile ecommerce cart element dynamically.

4. The system native ecommerce mobile application builder of claim 1 allows the user to design and build mobile ecommerce product price display element dynamically.

5. The system native ecommerce mobile application builder of claim 1 allows the user to design and build mobile ecommerce discount display element dynamically.

6. The system native ecommerce mobile application builder of claim 1 allows the user to design and build mobile ecommerce ad banners display element dynamically that are linking with products in the ecommerce website.

7. The system native ecommerce mobile application builder of claim 1 allows the user to design and build mobile ecommerce promotional banners display element dynamically that are linking with products in the ecommerce website.

8. The system native ecommerce mobile application builder of claim 1 allows the user to design and build mobile ecommerce product navigation element dynamically.

9. The system native ecommerce mobile application builder of claim 1 allows the user to design and build dynamically mobile ecommerce element of product deep link URI that will land the user in relevant product search result screens.

10. The system native ecommerce mobile application builder of claim 1 allows the user to design and build mobile ecommerce application content information screen dynamically.

11. A method for managing multiple native mobile application screen design theme or templates so that merchant user can switch between different themes or templates as they need with a click of a button and without any native application code build. The method provides benefit of loading theme or template from local data storage by template versioning system and mobile application cache storage system. This native ecommerce mobile application builder method gives benefit of configuring multiple language texts which can be rendered in the end user's mobile ecommerce application and view in their selected language from the list of available languages offered by the ecommerce merchant. Additionally this native ecommerce mobile application also gives benefits of multiple currency system for the product display in the native ecommerce mobile application.

12. The method of claim 11, wherein the theme or templates of mobile ecommerce application can be selected from web back end and it will be applied to the user's native ecommerce mobile application instantly without any code build.

13. The method of claim 11, wherein the theme or template information can be stored in local data storage as mobile storage cache.

14. The method of claim 11, wherein the active and latest theme or template design for the native ecommerce mobile application will be rendered by template versioning system.

15. The method of claim 11, allows merchant to offer multiple language text, images and video content information of their product or company to the end users in their native ecommerce mobile application.

16. The method of claim 11, allows merchant to offer and support for multiple currencies for the product information to display in end users' native ecommerce mobile application.
